(19) United States
(12) Patent Application Publication
(10) Pub. No.: US 2011/0012703 A1
(43) Pub. Date: Jan. 20, 2011

(54) MEMS ACTUATORS AND SWITCHES

(75) Inventors: Stéphane Ménard, Kirkland (CA); Jun Lu, LaSalle (CA); Nicolas Gonon, Dorval (CA); Normand Lassonde, Pincourt (CA)

Correspondence Address: FASKEN MARTINEAU DUMOULIN, LLP, STOCK EXCHANGE TOWER, SUITE 3700, P.O. BOX 242, 800 PLACE VICTORIA, MONTREAL, QC, H4Z 1E9, CA

(73) Assignee: Reseaux MEMS, Societe en commandite, Montreal (CA)

(21) Appl. No.: 12/839,185

(22) Filed: Jul. 19, 2010

Related U.S. Application Data
(63) Continuation of application No. 11/677,322, filed on Feb. 21, 2007, now abandoned.

(51) Int. Cl. H01H 61/00

(52) U.S. Cl. 337/36

(57) ABSTRACT

Micro-electromechanical systems (MEMS) actuators and switches exhibiting geometries and configurations providing superior operating characteristics and longer lifetimes.

### CROSS REFERENCE TO RELATED APPLICATION

This application is a continuation of U.S. patent application Ser. No, 11/677,322 filed Feb. 21, 2007.

### FIELD OF THE INVENTION

This invention relates generally to the field of Micro-Electromechanical Systems (MEMS) and in particular to actuators for chip level MEMS devices including switches.

### BACKGROUND OF THE INVENTION

MEMS devices are small movable mechanical structures advantageously constructed using conventional semiconductor processing methods. Oftentimes MEMS devices are provided as actuators—which have proven quite useful in a wide variety of applications.

A MEMS actuator is oftentimes configured and disposed in a cantilever fashion. Accordingly, it thus has an end attached to a substrate and an opposite tree end which is movable between at least two positions—one being a neutral position and the other(s) being deflected positions.

Common actuation mechanisms used in MEMS actuators include electrostatic, magnetic, piezo and thermal—the last of which is the primary focus of the present invention. The deflection of a thermal MEMS actuator results from a potential being applied between a pair of terminals commonly called “anchor pads” in the art—which potential causes a current flow thereby elevating the temperature of the structure. This in turn causes a part thereof to either elongate or contract, depending upon the particular material(s) used.

A known use of thermal MEMS actuators is to configure them as switches. Such MEMS switches offer numerous advantages over alternatives and in particular they are extremely small, relatively inexpensive, consume little power and exhibit short response times.

Given the importance of thermally actuated MEMS devices, structures that enhance their performance, reliability and/or manufacturability would represent a significant advance in the art.

### SUMMARY OF THE INVENTION

In accordance with an aspect of the invention, a MEMS actuator is provided with an improved latch which imparts less stress on cantilever members while exhibiting less creep than prior-art structures.

In accordance with another aspect of the invention, a MEMS actuator is provided with an improved hot beam having a tapered profile that advantageously exhibits a more uniform temperature profile across its length, thereby improving its reliability and operating life over prior art structures.

In accordance with yet another aspect of the invention, a MEMS actuator is provided with an improved cold beam having a tapered profile that advantageously distributes stress along its length more uniformly than with prior art structures.

### BRIEF DESCRIPTION OF THE DRAWING

Further features and advantages of the invention will become apparent upon review of the detailed description in conjunction with the drawing in which:

FIG. 1(A) is a plan view of a representative MEMS actuator;

FIG. 1(B) is a side view of the MEMS actuator of FIG. 1(A) disposed upon a substrate;

FIG. 1(C) is a plan view of a MEMS switch constructed from a pair of MEMS actuators of FIG. 1(A);

FIG. 2(A) is a plan view of a pair of MEMS actuators having asymmetric hot arm lengths according to the present invention;

FIG. 2(B) is a perspective view of the MEMS actuators of FIG. 2(A);

FIG. 3 is a plan view of a pair of MEMS actuators having asymmetric hot arm widths according to the present invention;

FIG. 4 is a plan view of a pair of MEMS actuators having tapered portions of a hot arm according to the present invention;

FIG. 5(A) is a plan view of a pair of MEMS actuators having a tapered cold arm according to the present invention;

FIG. 5(B) is a perspective view of the MEMS actuators of FIG. 5(A);

FIG. 6 shows a series of individual configurations 6(a)-6(d) of tip/flange configurations according to the present invention;

FIG. 7 is a plan view of an angled contact geometry for MEMS actuators according to the present invention;

FIG. 8 shows a series of individual operations 8(a)-8(e) on two actuator tip configurations including the angled geometry and conventional non-angled geometry according to the present invention.

### DETAILED DESCRIPTION

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

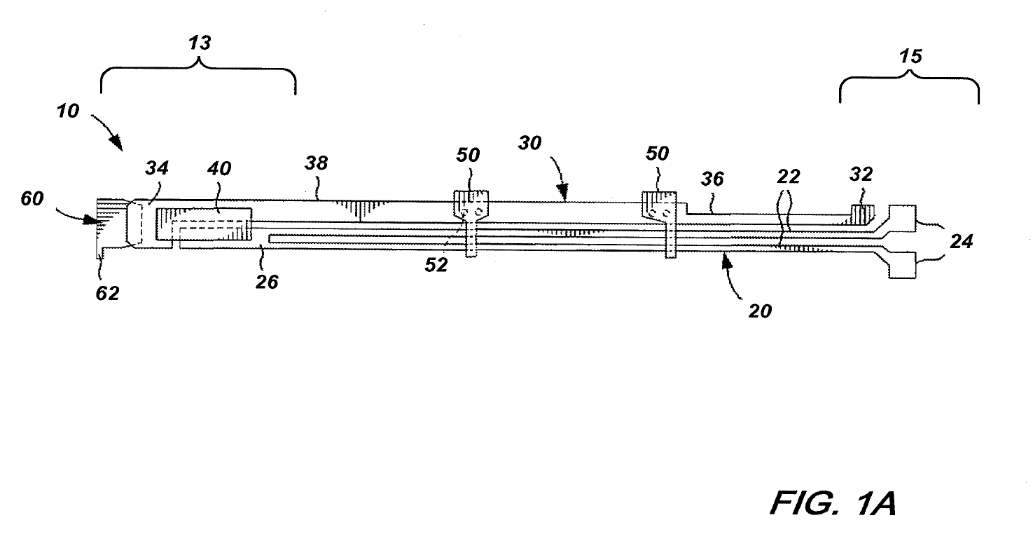

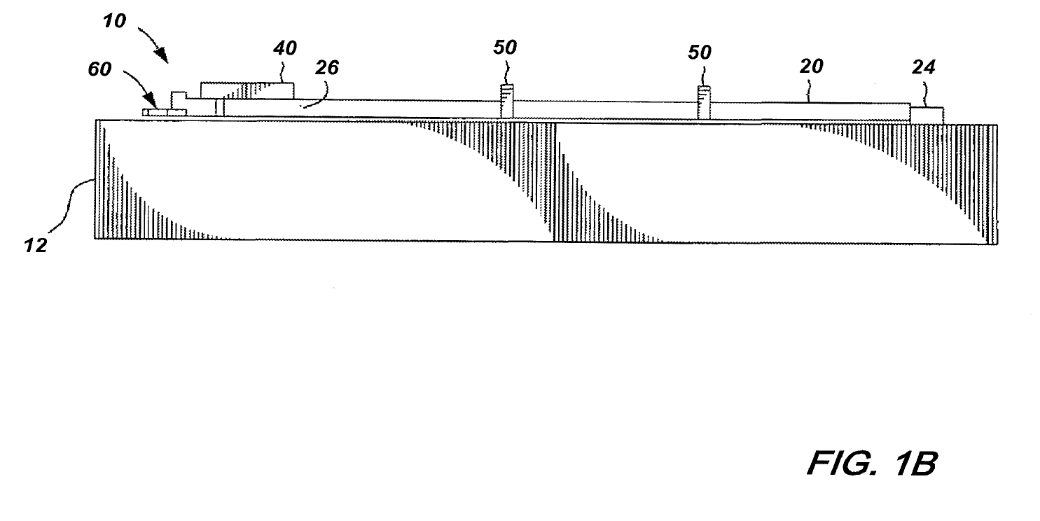

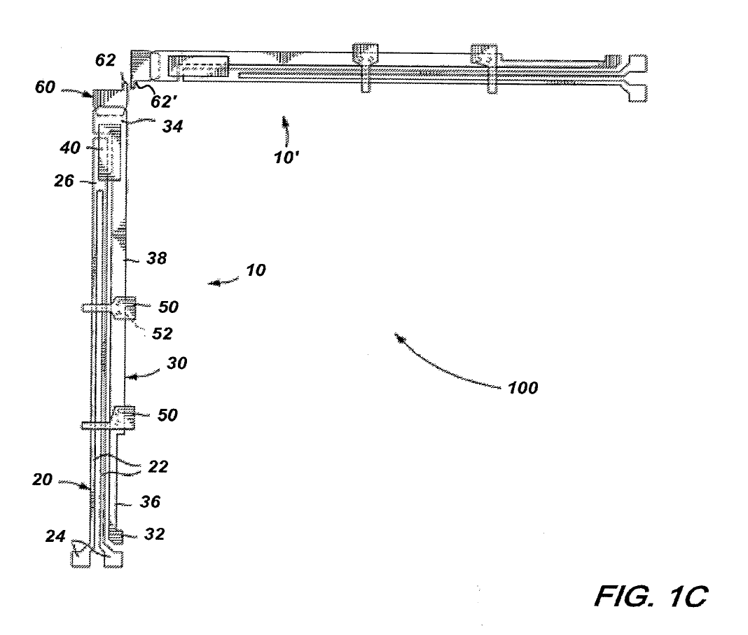

Referring simultaneously to FIGS. 1A, 1B, and 1C (collectively FIG. 1) there is shown an example of a representative MEMS cantilever actuator 10 mounted on a substrate 12. Such actuators are generally known in the art (See, for example U.S. Pat. No. 7,036,312 by the present inventors—the entire contents of which are incorporated by reference as if set forth at length herein) and have an immovable end 15 and a free end 13.

As its name implies, the free end 13 of the actuator 10 is capable of being moved. Such movement is effected by the actuation mechanism(s) inherent in the device. In this representative MEMS device shown in FIG. 1, and as shall be discussed in greater detail, the actuation mechanism is assumed to be thermal.

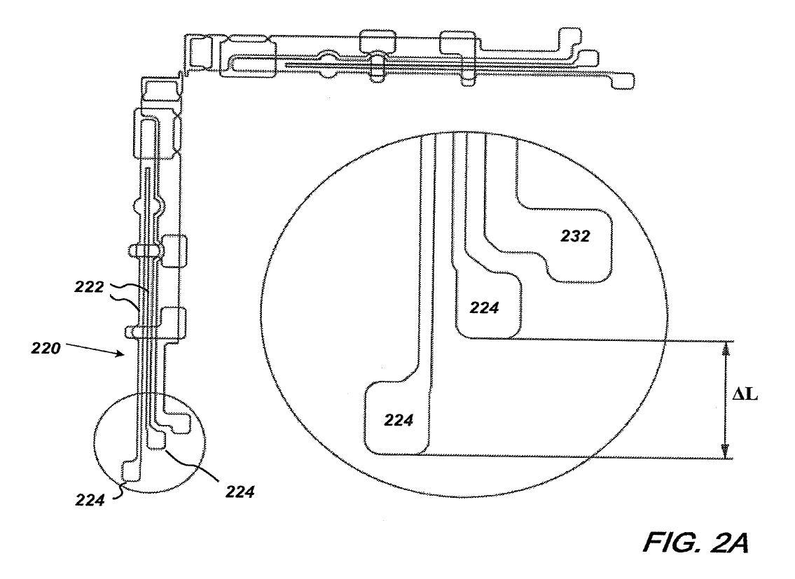

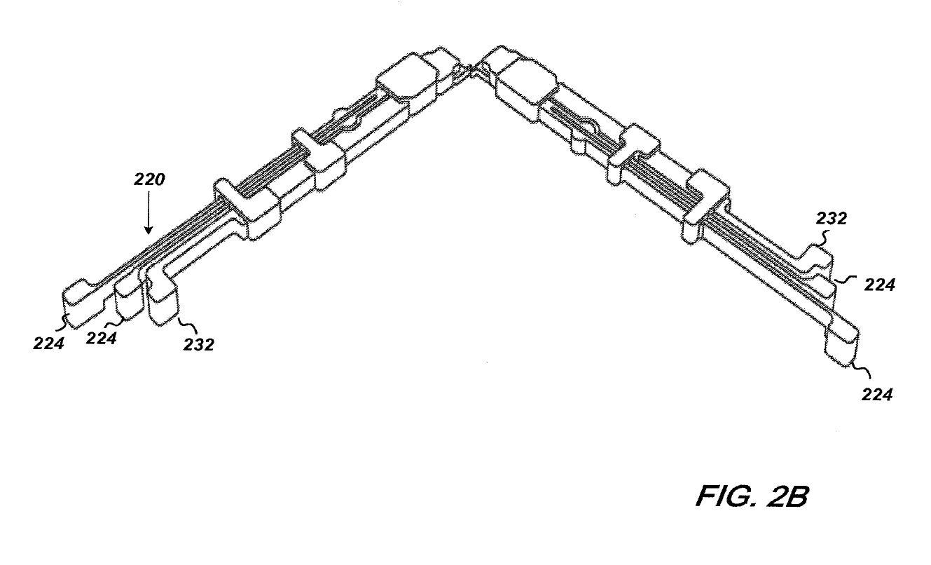

As shown in FIG. 1, the MEMS actuator 10 comprises a hot arm member 20 including two spaced-apart portions 22, each being provided at one end with a corresponding anchor pad 24 connected to a substrate 12. The spaced-apart portions 22 may be substantially parallel as shown in the FIG. 1 and connected together at a common end 26 that is opposite the anchor pads 24 and overlying the substrate 12, as shown in FIG. 2.

The actuator 10 also comprises a cold arm member 30 adjacent and substantially parallel to the hot arm member 20. The cold arm member 30 has at one end an anchor pad 32 connected to the substrate 12, and a free end 34 that is opposite the anchor pad thereof 32. The free end 34 is overlying the substrate 12.

Although these exemplary structures show substantially parallel members, it is noted that various shapes and geometries are possible—as shall be discussed in the context of the present invention.

In the representative embodiment shown, a dielectric tether 40 is attached over the common end 26 of the spaced-apart portions 22 of the hot arm member 20 and the free end 34 of the cold arm member 30. As can be appreciated, the dielectric tether 40 mechanically couples the hot arm member 20 to the cold arm member 30 while keeping them electrically isolated, thereby maintaining them in a spaced apart relationship with a minimum spacing between them to avoid a direct contact or a short circuit in normal operation as well as to maintain the required withstand voltage, which voltage is roughly proportional to the spacing between the members 20, 30.

The dielectric tether 40 is typically molded directly in place at a desired location and is attached by direct adhesion. Direct molding further allows having a small quantity of material entering the space between the parts before solidifying. Of course those skilled in the art will readily understand that the dielectric tether 40 can be attached to the hot arm member 20 and the cold arm member 30 in different manner(s) than the one shown in FIG. 1.

As shown, the dielectric tether 40 is located over the actuator 10, namely on the opposite side of the members with reference to the substrate 12. This has many advantages over previous MEMS actuators for which the dielectric tether, usually made of glass was provided under the member. In such configurations, the dielectric tether was typically made of glass and located under the members and constructed from thin layers of silicon oxide or nitride, which layers were very fragile. As can be readily appreciated, such prior-art dielectric tethers generally increased the complexity of the manufacturing process.

When constructed in this manner, the dielectric tether 40 is preferably made entirely of a photo resist material. A suitable material for this purpose is known in the trade as SU-8 which is a negative, epoxy-type, near-UV photo resist based on EPON SU-8 epoxy resin (from Shell Chemical). Other suitable materials include polyimide, spin on glass or other polymers or a combination thereof. Moreover, combining different materials is also possible.

With these structural relationships outlined, we may now describe the operation of this representative MEMS actuator. In particular, when a control voltage is applied at the anchor pads 24 of the hot arm member 20, an electrical current flows into both the first and the second portions 22 thereby heating the member. In the illustrated embodiment, the material used for making the hot arm member 20 is selected such that it increases in length as it is heated.

The cold arm member 30, however, does not elongate since there is no current initially flowing through it and it therefore is not actively heated. As a result of the hot-arm increasing in length and the cold arm staying substantially the same length, the free end of the actuator 10 is deflected sideward, thereby moving the actuator 10 from a neutral position to a deflected position. Conversely, when the control voltage is removed, the hot arm member 20 cools and shortens in length. As a result, the actuator 10 returns to its neutral position. Advantageously both movements may occur very rapidly.

In the embodiment shown in FIG. 1 the cold arm member 30 comprises a narrower section 36 adjacent to its anchor pad 32 in order to facilitate the movement between the deflected position and the neutral position. The narrower section 36 has a width laterally decreased from the exterior compared to a wider section 38 of the cold arm member 30. In one exemplary embodiment, the width decrease is at a square angle. Other shapes and geometries are possible, as will be shown later.

The actuator 10 in the embodiment shown in FIG. 1 includes a set of two spaced-apart additional dielectric tethers 50. These additional dielectric tethers 50 are transversally disposed over the portions 22 of the hot arm member 20 and over the cold arm member 30 and adhere to these parts.

It has been advantageous to provide at least one of these additional dielectric tethers 50 on an actuator 10 to provide additional strength to the hot arm member 20 by reducing their effective length in order to prevent distortion of the hot arm member 20 over time. Since the gap between the parts is extremely small, the additional tethers 50 reduce the risk of a short circuit between the two portions 22 of the hot arm member 20 or between that portion 22 of the hot arm member 20 which is the closest to the cold arm member 30 and the cold arm member 30 itself by keeping them in a spaced-apart configuration.

In those applications where the cold arm member 30 is used to carry high voltage signals, the portion 22 of the hot arm member 20 closest to the cold arm member 30 will deform, moving it towards the cold arm member 30, due to an electrostatic force between them which is caused by the high voltage signal. As can be appreciated, if the portion 22 of the hot arm member 20 gets too close to the cold arm member 30, a voltage breakdown can occur, possibly destroying the MEMS switch 100. Additionally, since the two portions 22 of the hot arm member 20 are relatively long, they tend to distort when heated to create the deflection, thereby decreasing the effective deflection stroke of the actuators 10.

As can be readily appreciated, using one, two or more additional dielectric tethers 50 may offer a number of advantages, including increasing the rigidity of the portions 22 of the hot arm member 20, increasing the deflection stroke length of the actuator 10, while decreasing the risk of shorts between the portions 22 of the hot arm member 20 and increasing the breakdown voltage between the cold arm member 30 and hot arm members 20.

The additional dielectric tethers 50 may advantageously be made of a material identical or similar to that of the main dielectric tether 40. When preparing the tethers, small quantities of materials are flowed between the parts before solidifying in order to improve the adhesion. In addition, one or more holes or voids 52 may be provided in the cold arm member 30 to receive a small quantity of material before it solidifies thereby improving its adhesion thereto.

FIG. 1 further shows that the actuator 10 comprises a tip member 60 attached to the free end of the cold arm member 30. While an actuator may be constructed without a tip member, as we shall show such tips facilitate the construction of MEMS switches from actuators.

When tip members are used to conduct electrical current, the surface of the tip member 60 may be preferably designed so as to lower the contact resistance when two of such tip members 60 make contact with each other. Those skilled in the art will recognize that this characteristic may be realized by employing tip members made of gold, or gold over-plated. Other possible tip materials for electrical conduction will be recognized in the art and include gold-cobalt alloys, palladium, etc. Generally, all that is required for such materials is that they provide a lower electrical resistance as compared to Ni, which is a preferred material for the cold arm member 30. Of course, other materials may be used for the hot arm member 20 and/or the cold arm members 30.

With continued reference to FIG. 1, it may be observed that the tip member 60 of the actuator 10 of a preferred embodiment include a lateral contact flange 62. This flange 62 is useful for connecting two substantially perpendicular actuators 10, as particularly shown in FIG. 1C. Such arrangement creates a MEMS switch 100.

As can now be understood and appreciated the MEMS switch 100 has two static positions, namely a closed position in which the first actuator 10 and the second actuator 10′ are mechanically engaged at and by their lateral contact flanges 62. Conversely, an open position is that in which they are not mechanically engaged at and by their lateral contact flanges. As can be appreciated, when an electrical potential is applied to one of the mechanically engaged actuators, they are effectively electrically engaged as well and as such an electrical current may flow through the two engaged actuators. Stated alternatively, when disengaged they are electrically isolated, there is no electrical continuity between the cold arm members 30.

With these structural relationships described, we may now explain how MEMS actuators operate. Note that when describing a direction of movement, it is with reference to the exemplary arrangements shown in this FIG. 1C. Those skilled in the art will of course recognize that different physical arrangements and relationships are possible, so a particular direction of movement is referenced for exemplary purposes only.

Returning to FIG. 1C, it is noted that to move from one position to the other (i.e., from open to closed or closed to open), the actuators 10, 10′ are operated in sequence. Briefly stated, the tip member 60 of the second actuator 10′ is deflected upward (away from actuator 10). Then, the tip member 60 of the first actuator 10 is deflected to its right. The control voltage which initiated the upward deflection of second actuator 10′ is removed or sufficiently diminished such that it (the second actuator) moves downward toward the first actuator 10 sufficiently to permit its flange 62′ to engage the back side of the flange 62 of the first actuator 10.

Continuing, the control voltage which initiated the rightward deflection of the first actuator 10 is then similarly removed or diminished, thereby causing it to return toward its neutral, undeflected position while causing the two flanges (62, 62′) to become mechanically engaged and permitting electrical engagement therebetween. When the cold arm members are so connected, an electrical signal or current then be transmitted between both corresponding anchor pads 32 of the two cold arm members 30. Advantageously, opening and closing the MEMS switch 100 is very rapid-typically occurring in only a few milliseconds.

When so operated, the MEMS switch 100 is effectively “latched” into position and will remain so unless specifically “unlatched”. As can now be understood and appreciated however, re-setting or “unlatching” the MEMS switch 100 to its open (“unlatched”) position is done by reversing the above-described operations.

Turning our simultaneous attention now to FIG. 2A and FIG. 2B (collectively “FIG. 2”) there is shown an alternative embodiment of the present invention. In particular, the embodiment shown therein is that exhibiting an asymmetric hot arm length.

More particularly, hot arm 220 is that member of the actuator 200 through which an electrical current is flowed and subsequently elongates and thereby deflects. The hot arm 220 includes two portions 222 each of the two having an anchor pad 224. As shown in that FIG. 2, one of the portions is longer than the other portion by a length ΔL as shown in the inset of FIG. 2A. In the preferred configuration shown, it is the outer portion that is longer by the amount ΔL. Operationally, by making the outer portion longer, the actuator exhibits better stress distribution over an actuator in which all of the members are the same length. Additionally, it also provides a more efficient actuation mechanism which reduces stress along the structure and reduces the temperature (current) required for actuation in the latched position.

More particularly, when a pair of actuators such as those shown in the perspective drawing FIG. 2B, are latched, the asymmetric configuration such as that shown here exhibits a much lower stress in that latched position. Also shown in this FIG. 2, both of the portions 222 of the hot arm member 220 are longer than the cold arm member, whose anchor pad is designated by 232.

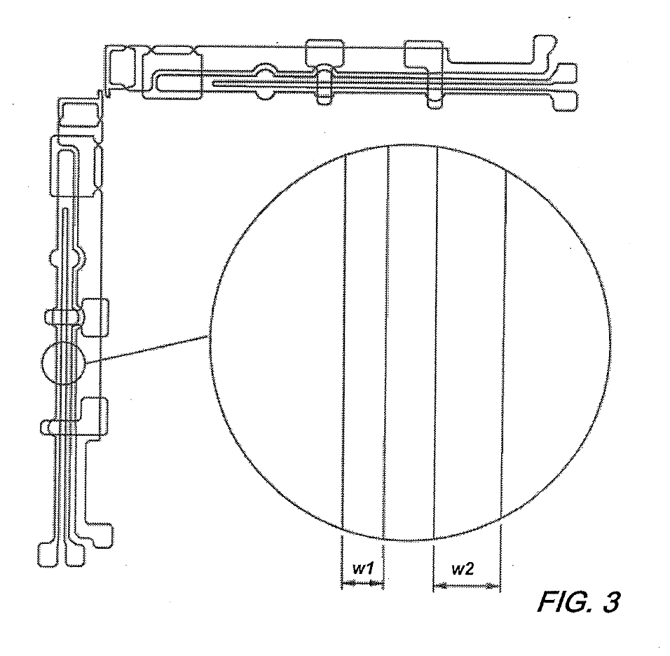

FIG. 3 shows yet an alternative configuration of the hot arm member wherein the two portions thereof do not exhibit the same width. In particular, one of the portions is shown having a width w1, while the other portion is shown having a width w2 where w1≠w2. Advantageously, narrowing the outer hot beam produces an effect similar to increasing its length.

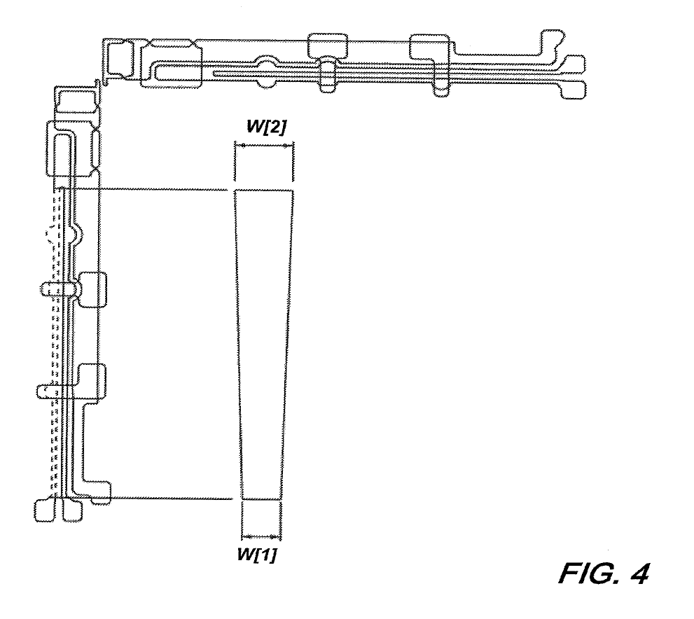

FIG. 4 shows yet another hot arm member configuration according to the present invention. In particular, the hot arm member 400 shown in that FIG. 4 has a portion where one end of the portion is wider than the other end of that portion. In the configuration shown, the end closes to the free end has a width w[2] while the end closest to the anchor pads has a width w[1] where w[1]<w[2]. When so configured, the taper serves as a “choke” to the electrical energy. As a result, the temperature of a hot arm member so configured will exhibit more uniform temperature distribution across its length and therefore a lower peak temperature for a given displacement.

As with the variations shown earlier, this tapered hot arm member 400 may have one or both of the portions exhibiting this tapered characteristic in one form or another. Once again, the particular materials chosen and the application will dictate the taper characteristics and which, if any, of the hot arm member portions will have the taper.

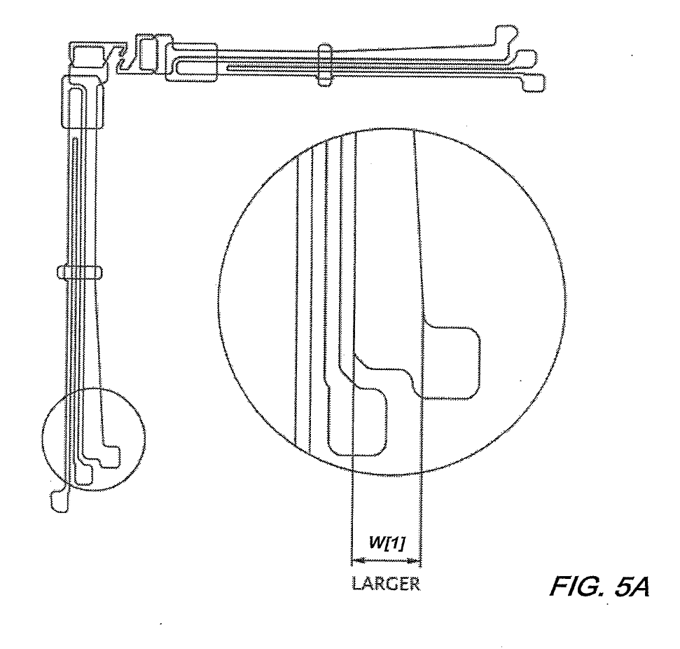

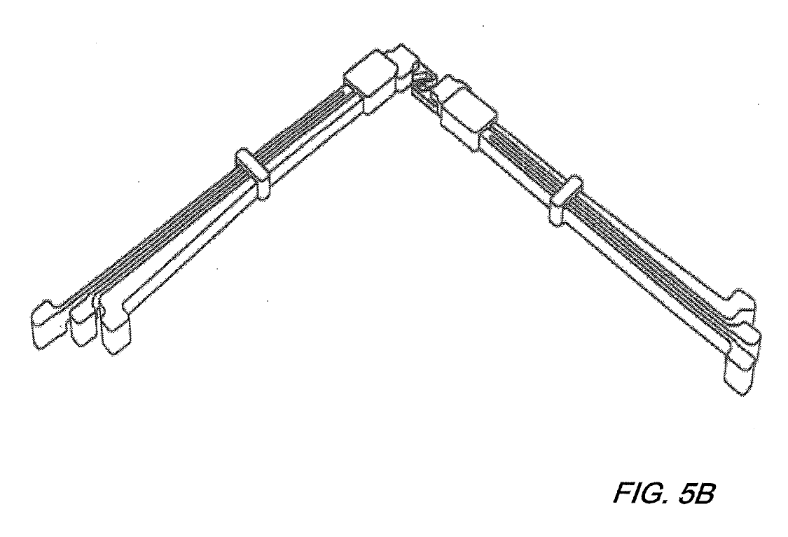

Turning simultaneously now to FIG. 5A and FIG. 5B (collectively “FIG. 5”) there is shown an actuator configuration according to the present invention whereby a cold arm member exhibits a tapered profile. In this configuration, the width of the cold arm member closest to the anchor pad has a width w[1] which is larger than the width of that cold arm member closes to its free end. Advantageously, this tapered cold arm profile distributes more uniformly any stresses introduced into that member. As a result, greater reliability is one result. More particularly, mechanical creep performance is enhanced.

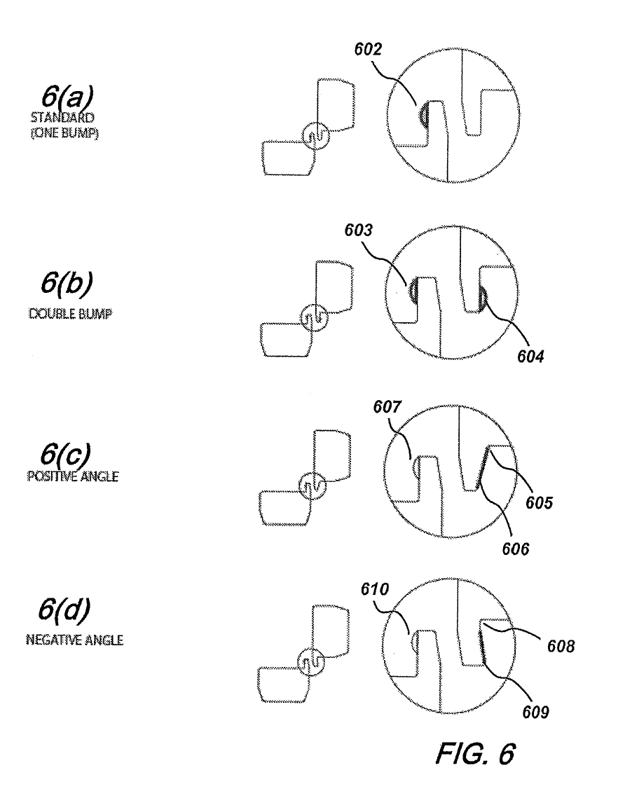

Further variations to the MEMS actuators of the present invention are shown in FIG. 6. More particularly, FIG. 6 shows a series of individual configurations 6(a)-6(d) wherein variations to the tip member flange(s) are shown.

With reference to FIG. 6(a) a one-bump configuration is shown. According to the present invention, one flange of the two tip members which latch has disposed thereon a “bump” 602 of material such as gold which advantageously improve contact resistance of the switch. This improvement is attributed, in part, to the fact that a much smaller surface area and therefore higher contact pressure is exhibited. In this exemplary configuration, the bump exhibits a substantially hemispherical geometry.

Similarly, the configuration shown in FIG. 6(b) is that of a “double bump” wherein each of the latch components of the tip members has a bump 603, 604, respectively. As can be appreciated, when so configured and properly aligned, such a configuration further minimizes the surface area of the latches that contact one another. As before, gold or other materials may preferably be used for the bumps. Additionally, it should be noted that while only a single bump was shown in 6(a) and one bump on each flange is shown in FIG. 6(b) those skilled in the art will appreciate that one or more bumps may be disposed upon a given flange as an application requires.

As can be appreciated, such configurations affect the “wiping” or cleaning of the latches as they become engaged/disengaged. As a result, the contact effectiveness and lifetime, is potentially improved. Advantageously, additional “self-wiping” configurations are possible according to the present invention.

FIG. 6(c) shows yet an alternative tip member flange configuration wherein one of the flanges exhibits a “positive” angle. As can be observed from this FIG. 6(c), the positive angle is characterized by an angle 605 that is greater than 90 degrees between the inner flange face 606 and the main tip member. This positive angle configuration may advantageously be combined with a bump configuration, such as the single bump configuration shown previously wherein a bump 610 is disposed on the inside face of the mating flange.

As can be readily understood, such angular flanges may increase the amount of friction between the moving flanges. As a result, a more forceful, self-wiping action is produced thereby enhancing its operational characteristics as noted above.

Finally, FIG. 6(d) shows a configuration having a “negative” angle. As can again be observed from the figure, the negative angle is characterized by an angle 608 that is less than 90 degrees between the inner-flange face 609 and the main tip member. Like the other configuration just shown, this negative angle configuration may be combined with other bump configurations, such as the single bump configuration.

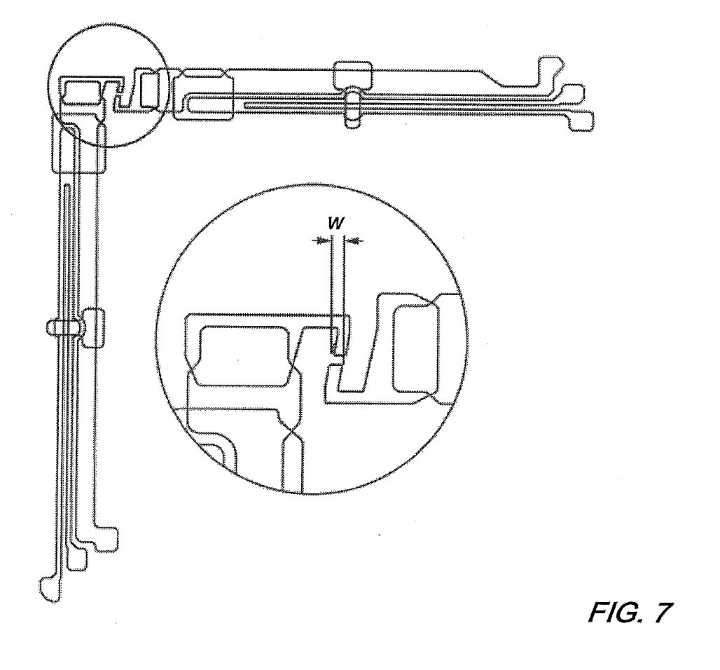

Turning now to FIG. 7, there is shown yet another contact configuration of mating tip members and their flanges. In particular, shown therein is a configuration wherein each of the mating flanges has a negative angle thereby producing an angled contact. When configured in this manner, a MEMS switch constructed from two such actuators will have a minimal stroke.

Shown in the inset of FIG. 7 is a distance w that is substantially the width of a given flange and any associated bumps disposed thereon. As noted before, the bump and/or the entire flange may be made from gold or other suitable materials. As can be appreciated by those skilled in the art, a minimal actuator stroke will produce lower stress in the actuators. Lower stroke permits a lower temperature to actuate and smaller deformations. Advantageously, the negative angle may be of a variety, depending upon the application. More particularly, negative angles of between 10 and 45 degrees are particularly useful. In other words, the negative angle (the angle between the flange and its respective tip member) will be substantially from 45 degrees to 80 degrees. Advantageously, the angled geometry provides a more positive latch while requiring fewer movements which may advantageously provide a longer, less stressful operating lifetime.

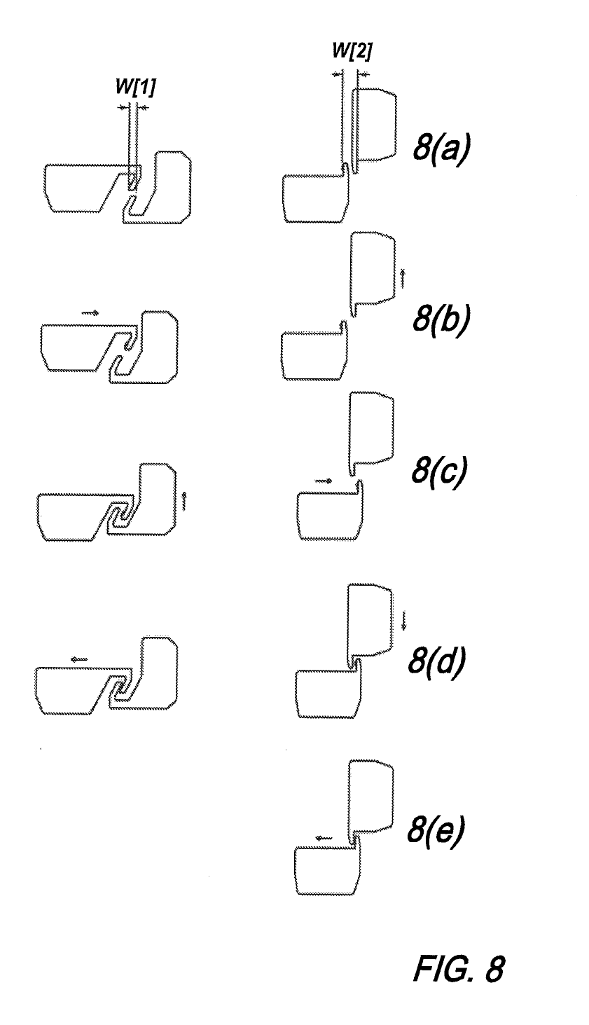

This lower stroke may be appreciated and understood by those skilled in the art with reference to FIG. 8 which shows a series of illustrations depicting the actuation latching of a representative actuator having an angled latch and straight latch. With reference to that FIG. 8, it can be seen that the stroke for the angled latch is depicted W[1] while that for the straight latch is depicted by W[2]. Those skilled in the art will readily recognize that not only are fewer movements required to engage the latch of the angled embodiment, but the displacement or stroke through which it must move is less as well. Advantageously, while a straight latch must first move apart, the angled latch may first move towards one another (FIG. 8(b)). Because they do not have to move apart to engage, fewer movements are required as well.

At this point, while the present invention has been shown and described using some specific examples, those skilled in the art will recognize that the teachings are not so limited. In particular, and according to the present invention, various permutations of the individual aspects of the present invention, for example angled geometry, bumps, tapered members, etc., may be used alone or in any useful combinations. Accordingly, the invention should be only limited by the scope of the claims attached hereto.

What is claimed is:

1. A Microelectromechanical (MEMS) actuator comprising:
a hot arm member; and
a cold arm member;
CHARACTERIZED IN THAT:
the hot arm member exhibits an asymmetric length.

2. The MEMS actuator of claim 1 wherein said asymmetric hot arm member includes a first portion and a second portion wherein one of said portions is longer than the other portion.

3. The MEMS actuator of claim 2 wherein one of said portions is wider than the other portion.

4. The MEMS actuator of claim 1 further comprising:
a substrate upon which a portion of the actuator is anchored; and
a second actuator anchored to the substrate at a portion thereof;
wherein each of said actuators includes a tip member which mechanically contact one another upon actuation.

5. The MEMS actuator of claim 4 wherein each tip member includes a flange and where at least one of said flanges includes a bump disposed thereon.

6. The MEMS actuator of claim 4 wherein each tip member includes a flange at least one of which is angled.

7. The MEMS actuator of claim 6 wherein an angle associated with each angled flange is between 45 and 90 degrees.

8. The MEMS actuator of claim 1 further comprising:
means for mechanically latching the actuator to a similar actuator.

9. The MEMS actuator of claim 8 further comprising means for increasing contact pressure associated with latched actuators.

10. The MEMS actuator of claim 8 further comprising means for self-wiping the mechanical latch.

11. A MEMS actuator comprising:
a hot arm member; and
a cold arm member having an asymmetric width.

12. The MEMS actuator of claim 11 further CHARACTERIZED IN THAT:
the cold arm member has a free end and a fixed end wherein the width of the cold arm member is wider at a portion thereof nearer the fixed end than the free end.

13. The MEMS actuator of claim 12 further CHARACTERIZED IN THAT:
the cold arm member includes a tip member at its free end for making mechanical and/or electrical contact with a tip member of another actuator.

14. The MEMS actuator of claim 12 further CHARACTERIZED IN THAT:
the tip member includes a means for increasing the contact pressure exerted by the tip member on the tip member of the other actuator

15. The MEMS actuator of claim 14 further CHARACTERIZED IN THAT:
the tip member includes a means for latching an actuator into a deflected position.

16. The MEMS actuator of claim 15 further CHARACTERIZED IN THAT:
the tip member includes a means for self wiping.

17. A MEMS switch comprising:
a substrate;
a first actuator anchored to the substrate; and
a second actuator anchored to the substrate;
wherein one of the actuators is an asymmetric actuator and mechanically contacts one another upon the application of an actuating voltage.

18. The MEMS switch of claim 17 further comprising a means for mechanically latching the two actuators together.

19. The MEMS switch of claim 18 further comprising a means for increasing the contact pressure between the mechanically latched actuators.

20. The MEMS switch of claim 18 further comprising a means for self-wiping the mechanical latching means.

21. A Microelectromechanical (MEMS) actuator disposed upon a substrate, said actuator comprising:
a hot arm member having an end anchored to the substrate and a movable free end; and
a cold arm member;
CHARACTERIZED IN THAT:
the hot arm member exhibits an asymmetric width.

22. The MEMS actuator of claim 21 FURTHER CHARACTERIZED IN THAT the anchored end of the hot arm member exhibits a width w1 and the free end exhibits a width w2, wherein w2>w1.

23. The MEMS actuator of claim 21 FURTHER CHARACTERIZED IN THAT the width of the hot arm member increases as one moves along its length away from the anchored end.

24. A method of operating a Microelectromechanical (MEMS) switch, said switch comprising:
a substrate;
a first actuator disposed upon the substrate, said first actuator having an anchored end and a free end including a latch;
a second actuator disposed upon the substrate, said second actuator having an anchored end and a free end including a latch;
wherein each of said first and second actuators are normally in an undeflected position and may be independently moved to a respective deflected position upon the application of a respective actuating voltage;
wherein the movements of the actuators are substantially perpendicular to one another over an actuating distance; the method of operating the MEMS switch comprising the steps of:
actuating one of the actuators such that its free end including the latch is deflected towards the free end of the other actuator;
actuating the other actuator such that its free end including the latch is deflected towards the free end of the other actuator; and
deactuating one of the deflected actuators such that the latches engage one another.

25. The method of claim 24 further comprising the step of deactuating the other deflected actuator.

26. The method of claim 25 wherein said latches are angled latches.
